(19) United States
(12) Patent Application Publication
(10) Pub. No.: US 2018/0266659 A1
(43) Pub. Date: Sep. 20, 2018

(54) DEVICE WITH REPLACEABLE OPTICAL FILTER

(71) Applicant: TE-FAN HO, TAIPEI CITY (TW)

(72) Inventor: TE-FAN HO, TAIPEI CITY (TW)

(21) Appl. No.: 15/459,427

(22) Filed: Mar. 15, 2017

(51) Int. Cl. F21V 9/10; F21V 17/00; G03B 15/02; G03B 17/56

(52) U.S. Cl. CPC F21V 9/10; F21V 17/002; G03B 17/566; G03B 17/565; G03B 15/02

(57) ABSTRACT

In a device with replaceable optical filter, a base is provided with a slot and an opening, and middle of the slot has a light-transmitting portion, each of two opposite sides of an inner edge of the slot is provided with at least one protruding portion. An elastic light-filtering member includes an elastic frame body and an optical filter arranged within the elastic frame body and exposed to the light-transmitting portion to filter light. A front end of the elastic frame body is provided with two arc portions, the elastic frame body gradually narrows from its rear end to the front end. Each of two opposite sides of the elastic frame body is provided with one concave portion whose position corresponds to a position of the protruding portion. The present invention directly extracts the optical filter in the slot without repeatedly disassembling the light-controlling device.

### BACKGROUND OF THE INVENTION

### Field of the Invention

The present invention relates to a lighting device for photography, particularly to a device with replaceable optical filter for rapidly replacing different color filters.

### Description of the Related Art

Presently, in order to make a theme figure or a theme object have a better hue or show the situation that people expect when taking a photograph, a light-controlling device is installed in front of a flashlight, whereby the flashlight can emit natural light or the light matching the originality for designing pictures. Thus, no matter a photographer takes persons indoors or outdoors, the images formed by perfect light are captured.

In addition to generating various light sources, the light-controlling device further has different color filters, which balances the difference of color temperature caused by different light sources or changes color of pictures. Color temperature denotes the color combination of the light reflected by an object in photography. Due to different light sources, the colors of the light reflected by the object are different. For example, the light of a cloudy day is inclined to blue, and the light of a fluorescent lamp is inclined to green, and the light of sunset is inclined to yellow. Although human eyes do not feel the difference of light, negatives can show it to result in inaccuracy of color temperature of images. Thus, color temperature is one of the important factors for affecting color. Thus, when the color temperature shifts, the color filter is used to turn the color normal. Besides, the filter to change color temperature purposely creates the effect of warm light or cold light. Changing light can create different atmospheres in photography. As a result, the color of light plays a significant role in photography and greatly improves the possibility of photography.

However, the filter in the market is arranged between the light-controlling device and a lamp presently. When taking photographs, the filter has to be replaced in response to the color temperature of the environment. Specifically, the light-controlling device is uninstalled from the lamp, and then the filter is replaced. After replacing the filter, the light-controlling device is installed to the lamp. Over time, the repeatedly-disassembling behavior costs a lot of time and leads to damage to photographic equipments.

To overcome the abovementioned problems, the present invention provides a device with replaceable optical filter, so as to solve the afore-mentioned problems of the prior art.

### SUMMARY OF THE INVENTION

A primary objective of the present invention is to provide a device with replaceable optical filter. According to the color of light required, different color filters are directly and rapidly replaced without repeatedly disassembling the light-controlling device, so as to balance the color temperature of images caused by external light.

Another objective of the present invention is to provide a device with replaceable optical filter, which has an elastic light-filtering member and a protruding portion at each of two opposite sides of an inner edge of a slot. The elastic light-filtering member is fastened within the slot using tensile force. A front end of the elastic light-filtering member is narrower and provided with arc portions whereby a user can conveniently insert the elastic light-filtering member.

A further objective of the present invention is to provide a device with replaceable optical filter, which effectively reduces wear of components and the friction caused by the fact that the elastic light-filtering member is inserted into the slot and improves endurance of components.

To achieve the abovementioned objectives, the present invention provides a device with replaceable optical filter, which comprises a base provided with a slot and an opening, and a middle of the slot has a light-transmitting portion, and the opening is arranged at an end of the slot, and each of two opposite sides of an inner edge of the slot is provided with at least one protruding portion; and an elastic light-filtering member. The elastic light-filtering member comprises an elastic frame body with a front end thereof provided with two arc portions, and the front end of the elastic frame body enters the opening whereby the elastic frame body is inserted into the slot, and each of two opposite sides of the elastic frame body is provided with one concave portion whose position corresponds to a position of the protruding portion, and the elastic frame body gradually narrows from its rear end to the front end; and an optical filter arranged within the elastic frame body and exposed to the light-transmitting portion.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view showing a device with replaceable optical filter according to an embodiment of the present invention;

FIG. 2 is an exploded view showing the device with replaceable optical filter according to an embodiment of the present invention;

FIG. 3 is a top view showing an elastic light-filtering member according to an embodiment of the present invention;

FIG. 4 is an exploded view showing the elastic light-filtering member according to an embodiment of the present invention;

FIGS. 5-7 are diagrams schematically showing continuous states of the elastic light-filtering member inserted into a slot according to an embodiment of the present invention; and

FIG. 8 is a diagram schematically showing usage of the device with replaceable optical filter according to an embodiment of the present invention.

### DETAILED DESCRIPTION OF THE INVENTION

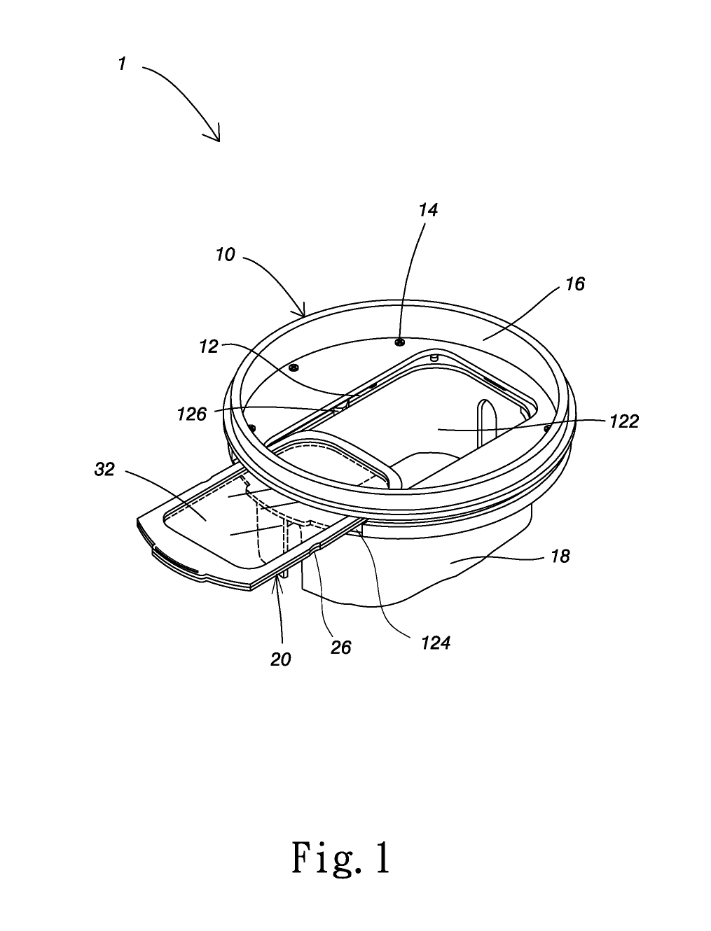

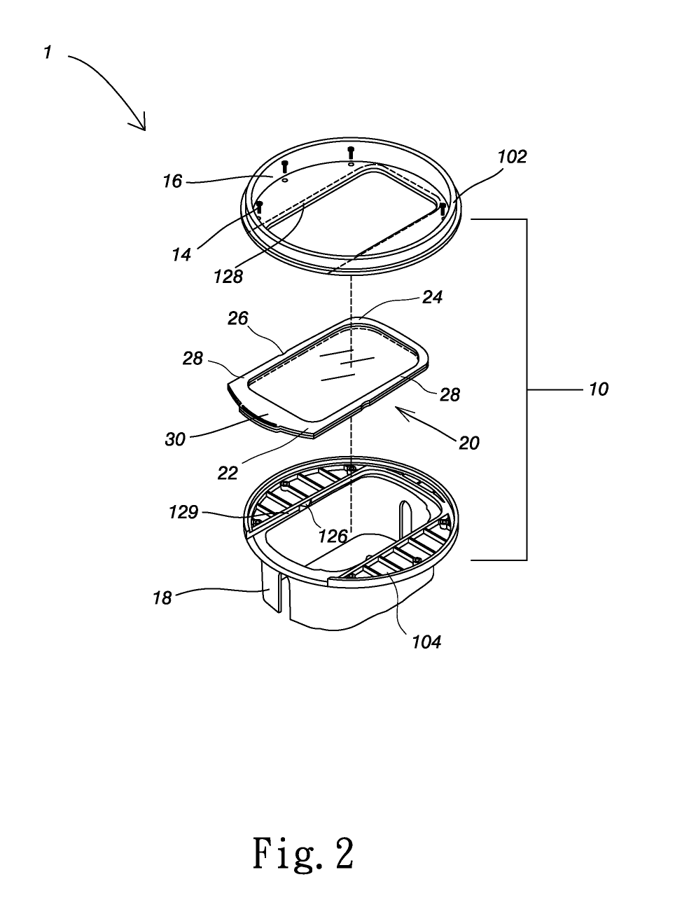

Refer to FIG. 1 and FIG. 2. The present invention provides a device with replaceable optical filter. The device comprises a base 10 provided with a slot 12, and a middle of the slot 12 has a light-transmitting portion 122. The base 10 is further provided with an opening 124 arranged at an end of the slot 12. Each of two opposite sides of an inner edge of the slot 12 is provided with at least one protruding portion 126. A lower surface of the base 10 has a flashlight installation portion 18, and the base 10 is installed on a flashlight using the flashlight installation portion 18. An upper surface of the base 10 is further and annularly provided with a light-controlling installation portion 16 to install a light-controlling component. The light-controlling component is a lambency flash diffuser, a radar reflector, a condenser, a sunshade, or a cellular light-controlling hood and used to change a type of projecting light of the flashlight. The base 10 is formed by an upper slot cover 102 combined with a lower slot cover 104. The upper slot cover 102 connects with the lower slot cover 104, and a plurality of fixed components 14 is used to fix the upper slot cover 102 and the lower slot cover 104. In the embodiment, the fixed components 14 are exemplified by screws used to lock the upper slot cover 102 and the lower slot cover 104. An upper surface of the upper slot cover 102 is provided with the light-controlling installation portion 16 and a lower surface of the upper slot cover 102 has a first hollow recess 128. A lower surface of the lower slot cover 104 is provided with a flashlight installation portion 18. An upper surface of the lower slot cover 104 has a second hollow recess 129. The second hollow recess 129 connects with the first hollow recess 128 to form the slot 12. The two protruding portions in the slot 12 are respectively arranged at two opposite sides of the second hollow recess 129.

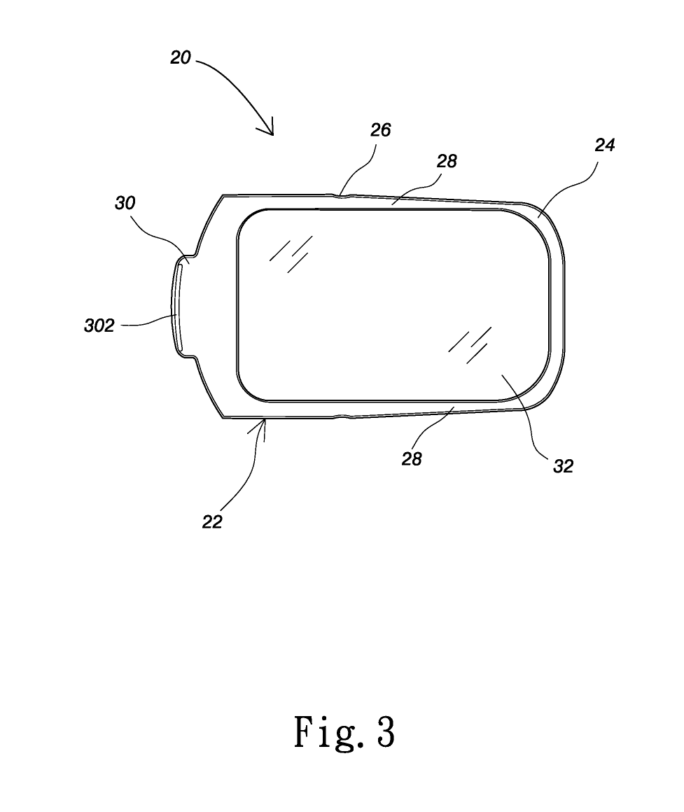

Refer to FIG. 1, FIG. 2 and FIG. 3. The slot 12 of the base 10 is further inserted with an elastic light-filtering member 20, wherein the elastic light-filtering member 20 comprises an elastic frame body 22 and an optical filter 32 arranged within the elastic frame body 22. The elastic frame body 22 is a plastic frame body whereby the elastic frame body 22 has elasticity, and thus the elastic frame body 22 is easily inserted into and fastened within the slot 12. An edge of the elastic frame body 22 has radiuses to soften lines of the edge of the elastic frame body 22, lest a user be cut and hurt by sharp corners of the edge of the elastic frame body 22. A front end of the elastic frame body 22 is further provided with two arc portions 24. The elastic frame body 22 gradually narrows from its rear end to the front end. Thus, the front end of the elastic frame body 22 easily enters the opening 124 whereby the elastic frame body 22 is inserted into the slot 12, lest the elastic light-filtering member 20 be jammed in the opening 124 of the slot 12. Besides, two frame bars 28 of two opposite sides of the elastic frame body 22 gradually narrow from the rear end to the front end having the arc portions 24. As a result, the front end of the elastic frame body 22 has softer elasticity to help insert the front end of the elastic frame body 22 into the slot 12. Each of the frame bars 28 of two opposite sides of the elastic frame body 22 is provided with one concave portion 26 whose position is arranged near the rear end and corresponds to a position of the protruding portion 126. When the elastic frame body 22 is completely inserted into the slot 12, the concave portion 26 is fastened with the protruding portion 126 to effectively fix the elastic frame body 22 in the slot 12, lest the elastic light-filtering member 20 drop from the slot 12. The elastic light-filtering member 20 further comprises an extracting portion 30 arranged on the elastic frame body 22 and at the rear end opposite to the arc portions 24 and emerging from the opening 124 of the slot 12, and each of a top and a bottom of the extracting portion 30 is provided with a rib 302, which is provided to the user for holding and used to replace the elastic frame body 22 and the optical filter 32. In addition, since the rear end of the frame bars 28 of the elastic frame body 22 is wider, the rear end of the elastic frame body 22 has a harder structure, which is easily held by the user and inserted into the slot 12. Although the rear end of the elastic frame body 22 has a harder structure than the front end, the rear end of the elastic frame body 22 has elasticity. When the concave portions 26 of two opposite sides of the elastic frame body 22 are fastened with the protruding portions 126 of the slot 12, the hard end can provides stronger fastening force. Moreover, since the rear end of the elastic frame body 22 still has elasticity, the elasticity provides tensile force to fasten the concave portions 26 of the elastic frame body 22 to the protruding portions 126, lest the elastic frame body 22 slip off the slot 12. When the elastic light-filtering member 20 is installed in the slot 12, the optical filter 32 clamped by the elastic frame body 22 is exposed to the light-transmitting portion 122 of the slot 12, thereby filtering color of light emitted by a flashlight.

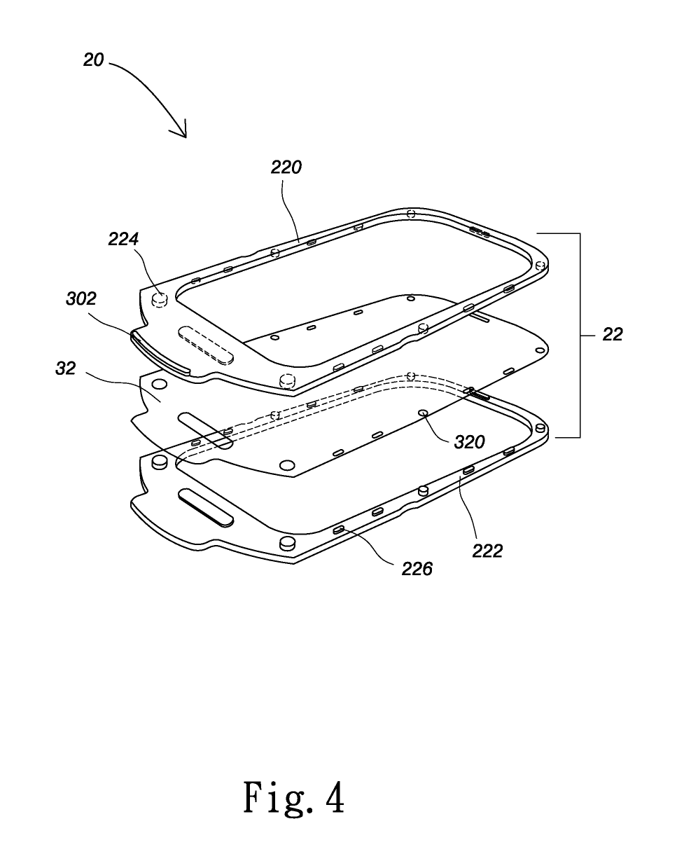

Refer to FIG. 4. The elastic frame body 22 is formed by combining a first elastic frame 220 with a second elastic frame 222. The first elastic frame 220 annularly provided with a plurality of recesses 224, and the second elastic frame 222 is annularly provided with a plurality of bumps 226. The plurality of bumps 226 are respectively fastened with the plurality of recesses 224. The optical filter 32 is annularly provided with a plurality of through holes 320 respectively corresponding to the plurality of bumps 226 of the second elastic frame 222, so that the optical filter 32 sleeves the plurality of bumps 226. When the first elastic frame 220 is combined with the second elastic frame 222, the optical filter 32 is clamped between the first elastic frame 220 and the second elastic frame 222.

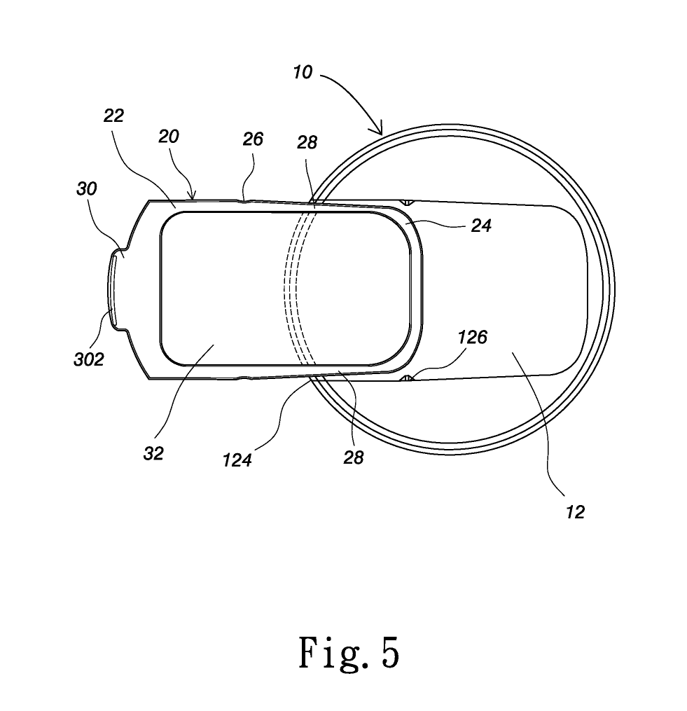

After describing the structure of the present invention, the present invention explains the process of inserting the elastic light-filtering member 20 of the device with replaceable optical filter 1 into the slot 12. Refer to FIG. 5. Since the front end of the elastic frame body 22 of the elastic light-filtering member 20 having the arc portions 24 is narrower than the opening 124 of the slot 12, the elastic light-filtering member 20 is successfully inserted into the slot 12 rather than jammed in the opening 124 when the front end of the elastic frame body 22 is inserted into the slot 12 through the opening 124. Using the arc portions 24, the elastic light-filtering member 20 is more easily inserted into the slot 12 when the arc portions 24 of the elastic light-filtering member 20 are jammed in the opening 124. Besides, two frame bars 28 of two opposite sides of the elastic frame body 22 gradually narrow from the rear end of the elastic frame body 22 to the arc portions 24. As a result, the front end of the elastic frame body 22 is more flexible and the rear end of the elastic frame body 22 is wider and harder. When the user holds the extracting portion 30, the user does not difficultly control the direction of inserting the elastic light-filtering member 20 due to too soft the rear end, so as to help insert the elastic light-filtering member 20 into the slot 12.

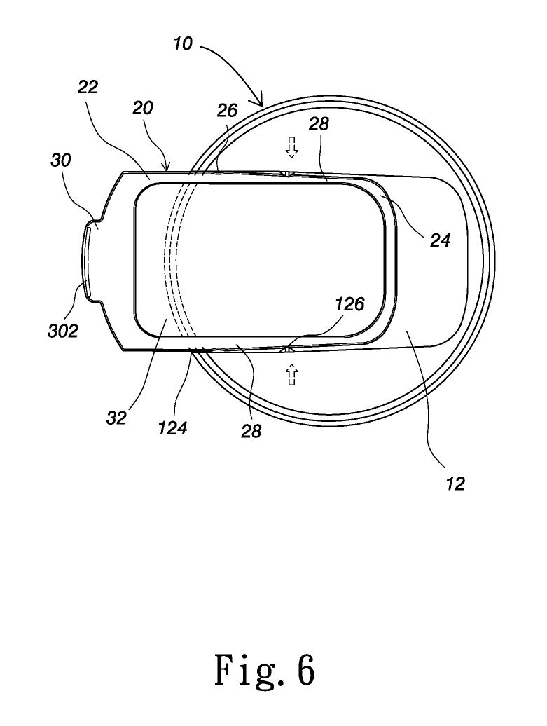

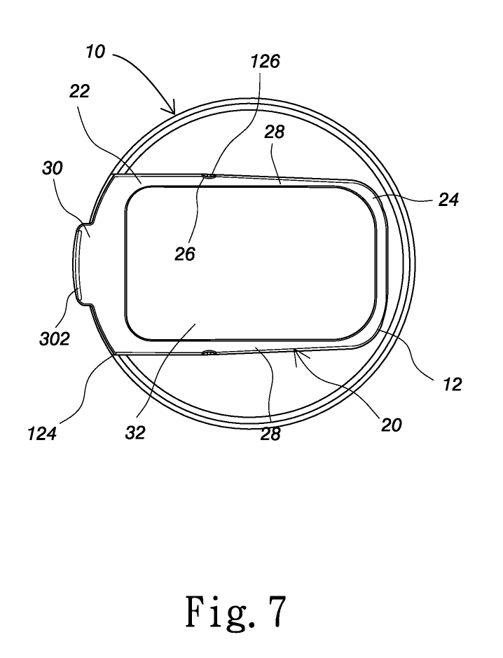

Refer to FIG. 6. When the elastic frame body 22 is inserted into the slot 12, the front end of the elastic frame body 22 is not jammed by the protruding portions 126 due to the fact that the elastic frame body 22 gradually widens from the front end to the rear end. The protruding portions 126 touch a wider part of the elastic frame body 22. The design with the narrow front and the wide rear can reduce friction between the protruding portions 126 and the elastic frame body 22 and wear caused thereof. The protruding portions 126 are slightly pressed against the elastic frame body 22 when the elastic frame body 22 touches the protruding portions 126. Since the elastic frame body 22 is like a spring with flexibility so that the elastic frame body 22 is successfully and completely inserted into the slot 12. Refer to FIG. 7. When the elastic frame body 22 is completely inserted into the slot 12, the protruding portions 126 in the slot 12 are respectively fastened with the concave portions 26 of the elastic frame body 22. Meanwhile, the protruding portions 126 are still pressed against the elastic frame body 22 slightly, so as to effectively fix the elastic frame body 22. On top of that, using tensile force, the elastic frame body 22 is fastened within the slot 12, whereby the elastic light-filtering member 20 cannot slip off easily.

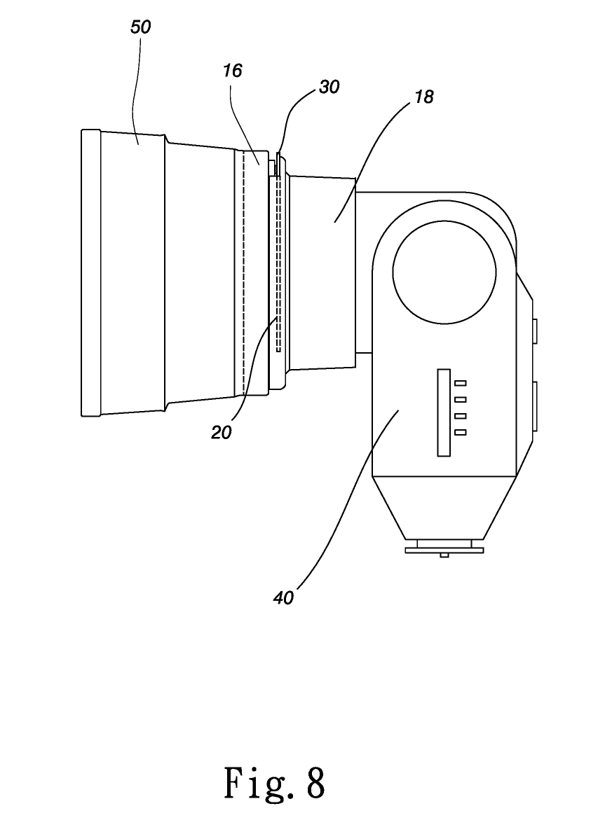

Refer to FIG. 1 and FIG. 8. FIG. 8 is a diagram schematically showing usage of the device with replaceable optical filter according to an embodiment of the present invention. The device 1 with replaceable optical filter is installed on a flashlight 40 using the flashlight installation portion 18 of the base 10. The light-controlling installation portion 16 of the base 10 is further provided with a light-controlling component 50 to change a type of a light source of the flashlight 40. Using the optical filter 32 of the elastic light-filtering member 20, the flashlight 40 projects light whose color is the same to the color of the elastic light-filtering member 20. Accordingly, the color temperature of the external light forming images can be changed when taking photographs, whereby a photographer takes ideal photographs. The extracting portion 30 of the elastic light-filtering member 20 is directly pulled so that the elastic light-filtering member 20 is extracted from the slot 12. Then, the elastic light-filtering member 20 is replaced with another to change the color temperature of the images. Therefore, the elastic light-filtering member 20 is only extracted from the slot 12 without painstakingly uninstalling the device 1 with replaceable optical filter from the flashlight 40, thereby rapidly replacing the elastic light-filtering member 20 of different color.

In conclusion, according to the color of light required by images, the present invention directly and rapidly replaces optical filters of different color without repeatedly disassembling the light-controlling device, so as to balance the color temperature of images caused by external light. Due to the elastic light-filtering member and the protruding portions at the opposite sides of the inner edge of the slot, the tensile force of the elastic light-filtering member effectively cooperates with the protruding portions to fasten the elastic light-filtering member within the slot. On account of the narrower front end of the elastic light-filtering member and the arc design, the user can conveniently insert the elastic light-filtering member. In addition, the present invention effectively reduces wear of components and the friction caused by the fact that the elastic light-filtering member is inserted into the slot and improves endurance of components.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A device with replaceable optical filter comprising:
a base provided with a slot and an opening, and a middle of said slot has a light-transmitting portion, and said opening is arranged at an end of said slot, and each of two opposite sides of an inner edge of said slot is provided with at least one protruding portion; and
an elastic light-filtering member comprises:
an elastic frame body with a front end thereof provided with two arc portions, and said front end of said elastic frame body enters said opening to insert said elastic frame body into said slot, and each of two opposite sides of said elastic frame body is provided with one concave portion whose position corresponds to a position of said at least one protruding portion, and said elastic frame body gradually narrows from its rear end to said front end; and
an optical filter arranged within said elastic frame body and exposed to said light-transmitting portion.

2. The device with replaceable optical filter according to claim 1, wherein an edge of said elastic frame body has radiuses.

3. The device with replaceable optical filter according to claim 1, wherein two frame bars of two opposite sides of said elastic frame body gradually narrow from said rear end to said arc portions.

4. The device with replaceable optical filter according to claim 3, wherein said elastic frame body further comprises:
a first elastic frame annularly provided with a plurality of recesses; and
a second elastic frame annularly provided with a plurality of bumps, and said plurality of bumps are respectively fastened with said plurality of recesses to clamp said optical filter between said first elastic frame and said second elastic frame, and said optical filter is annularly provided with a plurality of through holes respectively corresponding to said plurality of bumps of said second elastic frame.

5. The device with replaceable optical filter according to claim 1, wherein said elastic frame body is a plastic frame body.

6. The device with replaceable optical filter according to claim 1, wherein said elastic light-filtering member further comprises an extracting portion arranged on said elastic frame body and at said rear end opposite to said arc portions and emerging from said opening of said slot, and each of a top and a bottom of said extracting portion is provided with a rib to replace said elastic frame body and said optical filter.

7. The device with replaceable optical filter according to claim 1, wherein a surface of said base is further and annularly provided with a light-controlling installation portion to install a light-controlling component.

8. The device with replaceable optical filter according to claim 7, wherein said light-controlling component is a lambency flash diffuser, a radar reflector, a condenser, a sunshade, or a cellular light-controlling hood.

9. The device with replaceable optical filter according to claim 1, wherein a lower surface of said base has a flashlight installation portion, and said base is installed on a flashlight using said flashlight installation portion.

10. The device with replaceable optical filter according to claim 1, wherein said base further comprises:
an upper slot cover with an upper surface thereof provided with an light-controlling installation portion, and a lower surface of said upper slot cover has a first hollow recess; and
a lower slot cover correspondingly combined with said upper slot cover, and a lower surface of said lower slot cover is provided with a flashlight installation portion, and an upper surface of said lower slot cover has a second hollow recess, and said at least one protruding portion is arranged at each of two opposite sides of said second hollow recess, and said second hollow recess connects with said first hollow recess to form said slot.

11. The device with replaceable optical filter according to claim 10, wherein said base further comprises a plurality of fixed components to fix said upper slot cover and said lower slot cover.

12. The device with replaceable optical filter according to claim 11, wherein said fixed components are screws.
